(19) United States
(12) Patent Application Publication
(10) Pub. No.: US 2010/0055961 A1
(43) Pub. Date: Mar. 4, 2010

(54) TERMINAL POSITION ASSURANCE MEMBER FOR ELECTRICAL CONNECTOR

(75) Inventors: Galen M. Martin, Camp Hill, PA (US); Keith Richard Foltz, Duncannon, PA (US); John M. Whitefoot, Lake Orion, MI (US)

Correspondence Address: TYCO TECHNOLOGY RESOURCES, 4550 NEW LINDEN HILLS ROAD, SUITE 140, WILMINGTON, DE, 19808, US

(73) Assignee: Tyco Electronics Corporation, Berwyn, PA (US)

(21) Appl. No.: 12/201,435

(22) Filed: Aug. 29, 2008

(51) Int. Cl. H01R 13/62

(52) U.S. Cl. 439/345

(57) ABSTRACT

A connector assembly is comprised of a connector housing and a terminal position assurance member (TPA). The connector housing has a latch which abuts with a tine on the TPA. The terminal, when received in the fully inserted position, deflects the tine, and the TPA may move to its fully locked position.

### RELATED APPLICATION

This application is related to application Ser. No. ______ (Attorney Docket E-AV-00426) concurrently filed herewith, the entirety of which is incorporated herein.

### FIELD OF THE INVENTION

The subject application relates to an electrical connector, and more particularly to a connector system having a terminal position assurance member (TPA).

### BACKGROUND OF THE INVENTION

In various applications of electrical connectors, devices are utilized to lock the terminals in place and to assure that they are in proper position within the electrical connector. One such field is in the automotive field where the application typically a terminal position assurance mechanism (TPA) which assures that the terminals are in proper position longitudinally within the respective cavities. This prevents an improper mating of a corresponding electrical connector, where some of the lines are open due to one or more terminals not being fully loaded.

Certain electrical connectors are provided with housings having cavities extending therethrough for receiving terminals, each cavity provided with a resilient locking latch integrally molded with the housing for locking a terminal inserted therein. In order to further secure the terminals within the housing, it is common to provide a secondary housing member that is moveable against the locking lances to prevent the locking lances from outwardly biasing. In other words, the locking lances are blocked into their latching position. It is known to provide the secondary member pre-assembled to the housing in a pre-assembly position that allows insertion of the terminals into the connector cavities. The secondary member can then be moved to a fully locked position whereby the terminals are locked in the cavities.

In essence, these TPAs constitute front-loaded wedges that are shipped in a pre-stage position, which are intended to be activated, or moved into their final position, after the terminals are assembled into the housing. The TPA has a pre-locked position, but the TPA senses a partially inserted terminal, not the absence of a terminal. Traditionally, these connectors are shipped in bulk to the end user or harness maker, where the wire harnesses are made, wires crimped to the terminals, and terminals inserted into the housing cavities. Thereafter, the TPA member is moved into the final position. However, one of the shortcomings of present TPA designs is that they are designed to indicate the presence of a partially inserted contact but not the absence of a contact from a housing cavity. Furthermore, it would be advantageous if the TPA were prevented from moving, by way of a positive stop engagement between the TPA and the housing, but where the design also prevents any breaking of the TPA when excessive force is exerted.

Earlier TPA designs are shown in U.S. Pat. Nos. 6,827,609 and 7,066,773 which show connector assemblies having a TPA having a pre-latched position preventing inadvertent activation.

### BRIEF SUMMARY OF THE INVENTION

The objects have been accomplished by providing an electrical connector assembly, comprising a housing member having a housing body portion defining at least one terminal receiving cavity extending therethrough. A terminal retaining latch at least partially overlies the at least one terminal receiving cavity. The free end of the terminal retaining latch has at least one end surface angled relative to a longitudinal axis. A TPA has a tine extending towards the terminal retaining latch when in a pre-locked position, and the tine free end has at least one complementary surface cooperating with the at least one angled surface, and the tine comprises an engagement member thereon. A terminal is receivable in the at least one terminal receiving cavity and engages the engagement member when fully positioned therein.

In another embodiment, an electrical connector assembly comprises a housing member comprising a housing body portion defining at least one terminal receiving cavity extending therethrough. A terminal retaining latch at least partially overlies the at least one terminal receiving cavity. A TPA has a tine extending towards and abutting the terminal retaining latch when in a pre-locked position, and is positionable beneath the terminal retaining latch when a terminal is received in the at least one terminal receiving cavity and fully positioned therein. The TPA and the terminal retaining latch have cooperating and angled interlocking planar surfaces.

### BRIEF DESCRIPTION OF THE DRAWINGS

FIG. 1 shows a front perspective view of the assembled electrical connector of the present disclosure;

FIG. 2 shows an exploded view of the electrical connector of FIG. 1 together with an electrical terminal poised for receipt, and a mating connector poised for connection to the connector assembly;

FIG. 3 is a perspective view similar to that of FIG. 2, shown from the opposite perspective;

FIG. 4 is a cross-sectional view through lines 4-4 of FIG. 2;

FIG. 5 is a cross-sectional view similar to that of FIG. 4 showing the electrical terminal position assurance member in a first pre-latched condition;

FIG. 6 is an enlarged portion showing the TPA and connector housing latch in an interlocked position;

FIG. 7 shows a view similar to that of FIG. 5 with the electrical terminal shown in a partially inserted position with the latch deflected downwardly;

FIG. 8 shows the terminal position assurance member in its second or fully locked condition, with the TPA positioned under the latch;

FIG. 9 shows a cross-sectional view similar to that of FIG. 5 showing an alternate version of the TPA designed for relieving overstress; and

FIG. 10 shows the TPA of FIG. 9 in a break away condition.

### DETAILED DESCRIPTION OF THE INVENTION

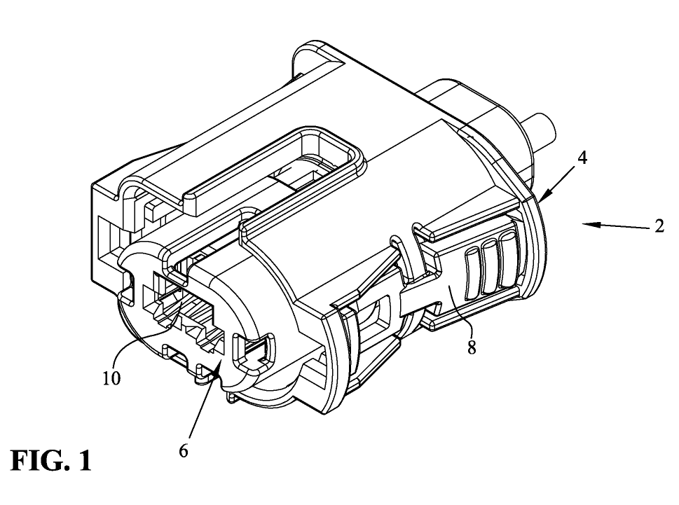

With reference first to FIG. 1, the electrical connector assembly is shown at 2 which is generally comprised of a connector housing member 4 and a terminal position assurance member (TPA) 6. The connector housing 4 would generally include latches 8 for connection to a mating connector and a terminal receiving cavity 10 would be formed by the combination of TPA 6 and connector housing 4.

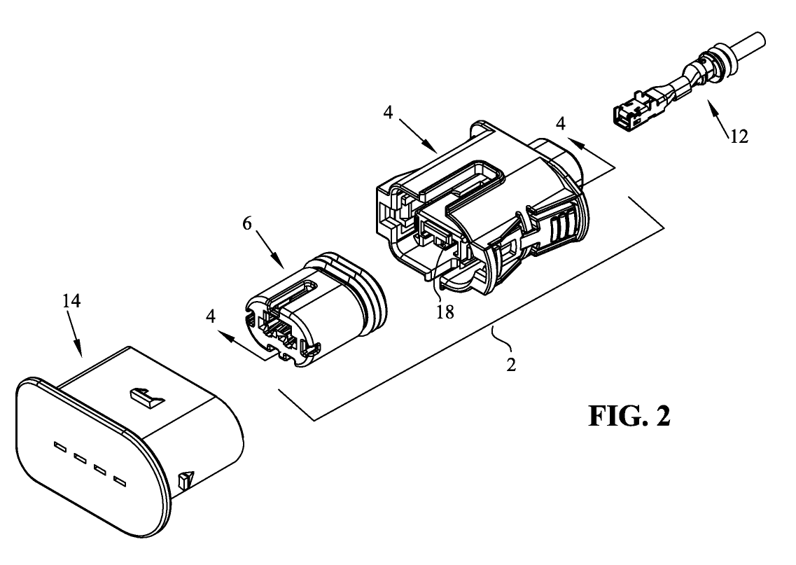

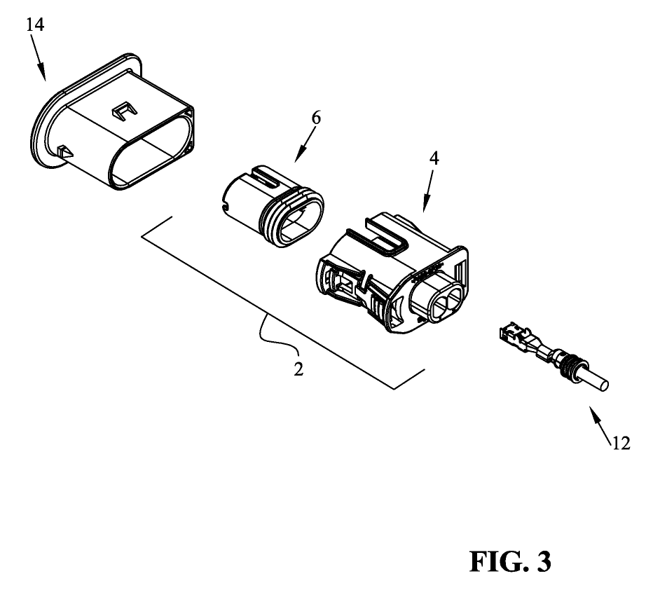

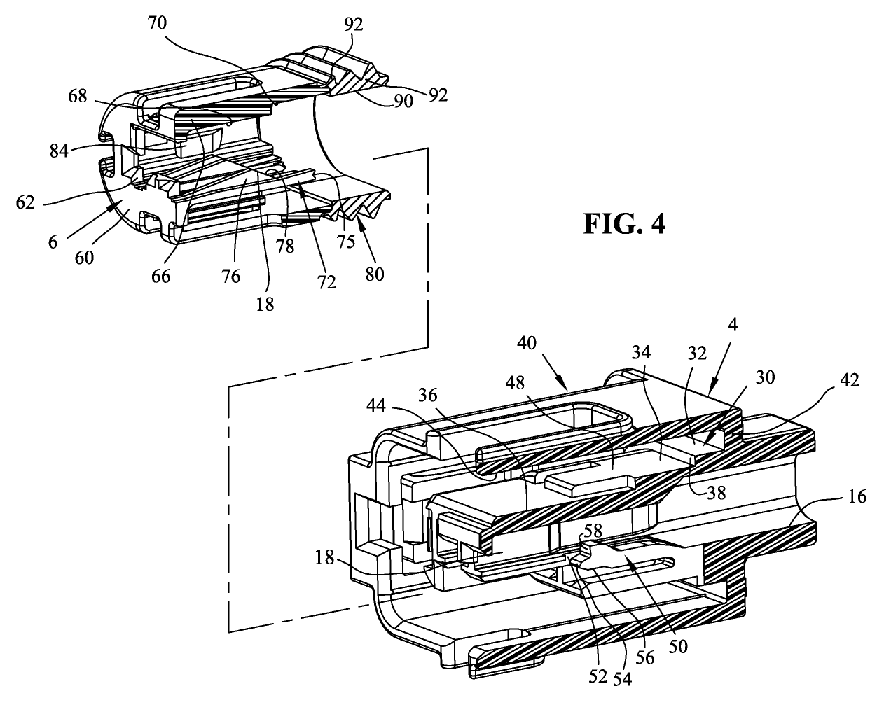

With reference now to FIGS. 2 and 3, TPA member 6 is shown in an exploded manner away from connector housing 4 and electrical terminal 12 is shown poised for receipt from a rear side of connector housing 4. A mating connector 14 is shown poised from a front side of connector assembly 2, which would be complementary with connector assembly 2. It should be understood that the mating connector 14 is shown somewhat generically, in that it could take many forms. It could be another connector housing having a plurality of wires connected thereto, or alternatively, could have a printed circuit board mounted thereto. Still alternatively, mating connector 14 could be a portion of an electronic device such as a controller, or the like. As shown best in FIG. 4, terminal 12 would be receivable through a rear entry 16 (FIG. 4) for positioning within cavity portion 18 (FIG. 2).

With respect now to FIG. 4, the connector housing 4 will be described in greater detail. Connector housing 4 is defined by a housing central body portion 30 defining a first outer surface 32, a first undercut surface at 34, and a second undercut surface at 36. The intersection of surfaces 32 and 34 also define shoulder 38. A shroud wall 40 is integrally connected to the central body portion 30 at a position 42 where the shroud wall 40 extends forwardly therefrom. Shroud wall 40 has an internal surface defined at 44 which together with the surfaces 32, 34 and 36 define a gap 46 therebetween. Central body portion 30 also includes a side wall 48, which includes first and second latch members (not shown) which are more fully described herein.

As also shown in FIG. 4, an integrated terminal retaining latch 50 extends between the rear entry portion 16 and the cavity portion 18 and resides within an opening 52 of the connector housing, and at least partially overlying cavity portion 18. Opening 52 allows the latch 50 to resile upwardly and downwardly in order to allow the entry of a terminal within the cavity portion 18, as is known in the art. Finally latch 50 includes a free end having a convex projection 54, a camming surface 56 and a latching surface 58 as described in greater detail herein. Convex projection 54 is comprised of planar surfaces which are angled relative to a longitudinal axis of cavity 10.

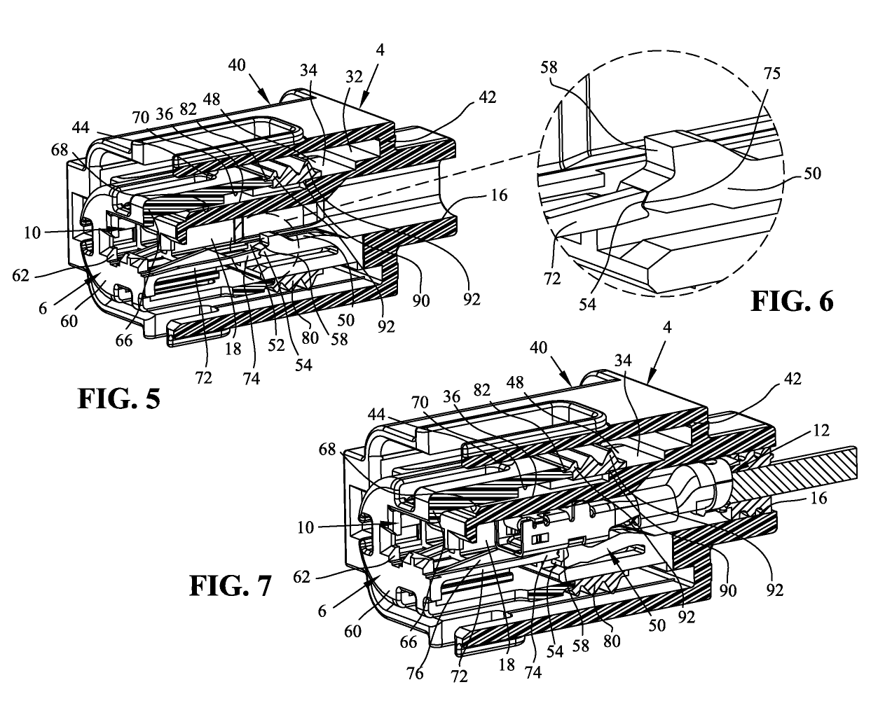

With respect still to FIG. 4, TPA 6 is defined by a front wall 60 having apertures 62 therethrough which together with cavity 18 define terminal receiving cavities 10 (FIG. 1). TPA 6 further includes a wall 66 which is complementary to central body portion 30 and includes a first surface 68 which complements surface 36, and an undercut surface 70 which complements surface 34. TPA 6 further includes a tine 72, that includes a free end 74 having a convex tip or projection 75. Convex tip 75 is comprised of planar surfaces which are angled relative to a longitudinal axis of cavity 10. Tine 72 also includes an integral engagement member, which is shown herein as a cam member 76, having a camming surface 78. TPA 6 also includes sidewall 82 having latching lug 84 (only one of the two sidewalls 82, and one of the two latching lugs 84 may be viewed in FIG. 4), which help to define the pre-locked position shown in FIG. 5.

With the components as described above, the assembly of electrical connector assembly 2 will now be described. First, TPA 6 is positioned relative to connector housing 4 as shown in FIG. 4, and moved to a position shown in FIG. 5 where surfaces 68 and 70 may cooperate with surfaces 36 and 34, respectively, as described above. This position would be defined by an interlocking of a first latching lug 84 and latch members on sidewall 48. TPA 6 is movable to the position shown in FIGS. 5 and 6 where the concave recess 75 of the free end 74 of tine 72 abuts and interlocks with the convex tip 54 of latch 50. At this point, TPA 6 cannot move into its fully locked position due to the abutment of the concave recess 75 and the convex tip 54. This is best shown in the enlarged view of FIG. 6. This positive stop prevents the TPA 6 from inadvertently seating, for example during shipping, or anytime prior to the insertion of the contacts.

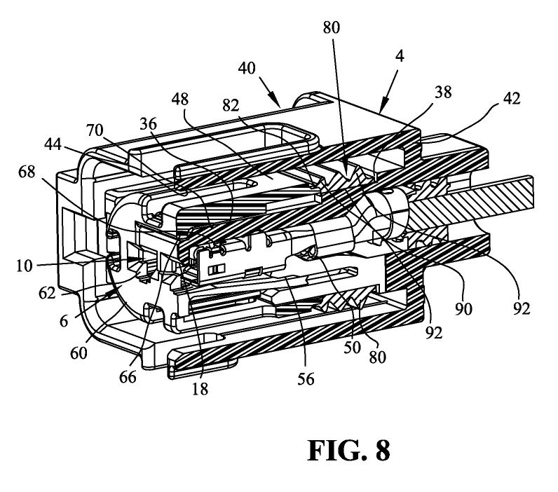

Electrical terminal 12 may now be positioned in entry 16 and moved forwardly to deflect latch 50 downwardly as shown in FIG. 7. When electrical terminal 12 is moved further forward into the cavity portion 18, two events occur; first, and starting from the position shown in FIG. 7, electrical terminal 12 engages camming surface 78 (FIG. 4) of cam member 76 which deflects the entire tine 72 downwardly, thereby moving free end 74 away from the position shown in FIG. 7; and second, when electrical terminal 12 is fully loaded, latch 50 snaps back into the position shown in FIG. 5. TPA 6 may now move into the fully locked position as shown in FIG. 8, with the entire tine 72 sliding against camming surface 56 and underneath latch 50. When TPA 6 is in the fully locked position of FIG. 8, seal 80 is also assured to be in its properly located position engaged against inner shoulder 38 and with surface 90 against surface 34. This position would be defined by an interlocking of a second latching lug 84 and a latch member on sidewall 48.

It should be appreciated that while the above embodiment shows a concave recess 75 at a free end 74 of the TPA tine 72, and a convex projection 54 at the end of latch 50, that these could be alternated with a concave recess at the end of the latch 50 and the convex tip at the end of the tine 72.

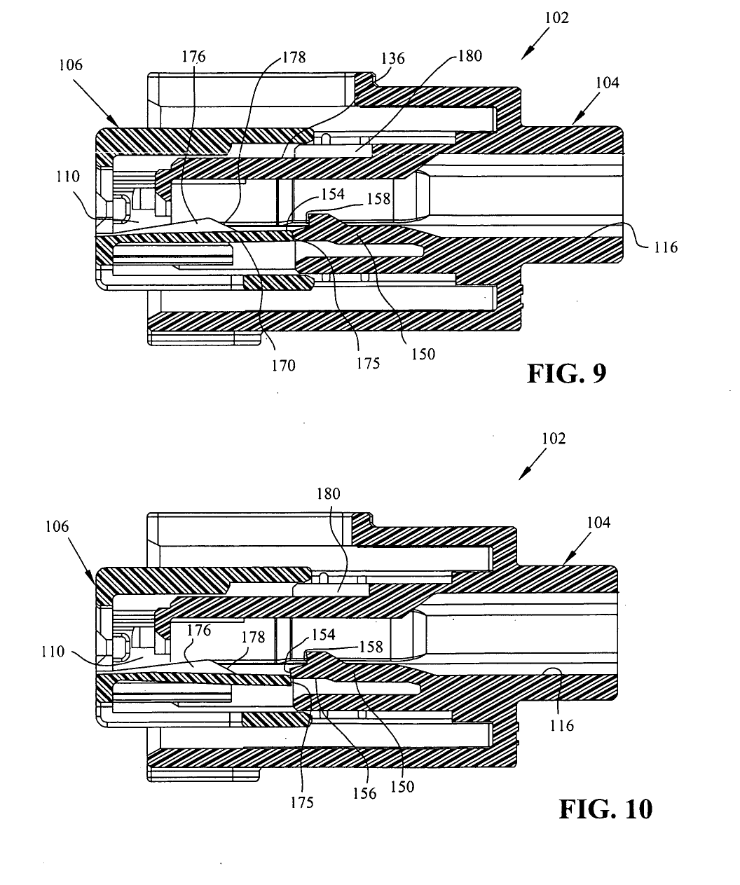

With reference now to FIG. 9, an alternate embodiment is shown as electrical connector assembly 102 having a housing member 104 and a TPA 106. Housing member 104 is similar to housing member 4, having a terminal receiving cavity 110, rear entry 116, and a latch 150 having a free end 154, and a latching surface 158.

TPA member 106 has tine 170 having free end 175, camming member 176 and camming surface 178. Housing member 104 could have a discrete seal 180 positioned on surface 136 rather than having the seal integrated with TPA 106. In this embodiment, the free end 154 of the latch 150 and the free end 175 of the tine 170 have cooperating angles, defining angled interengaging planar surfaces. For example, the free end 175 is angled rearwardly and downwardly. As such, when an excessive force is exerted on TPA 106, the tine 170 gives way as shown in FIG. 10, and projects downwardly. Further force on TPA 106 would cause tine 170 to extend under surface 156, preventing it from buckling or snapping. It should be appreciated the angle of inclination could be designed for any maximum force on TPA 106.

Thus, TPA 106 would cooperate with housing 104, in an identical manner as described above with respect to TPA 6 and housing 4, with the exception that TPA 106 and housing 104 would not interlock as shown in FIG. 6. Rather, tine 170 abuts latch 150, but has a pre-determined breakaway force, determined by the angle of the surfaces 154, 175.

1. An electrical connector assembly, comprising:
a housing member comprising a housing body portion defining at least one terminal receiving cavity extending therethrough, and a terminal retaining latch at least partially overlying the at least one terminal receiving cavity, the free end of the terminal retaining latch having at least one end surface angled at an incline relative to a longitudinal axis;
a terminal position assurance member (TPA) having a tine extending towards the terminal retaining latch when in a pre-locked position, the tine free end having at least one complementary inclined surface cooperating with the at least one angled surface, and the tine comprising an engagement member thereon; and
a terminal receivable in the at least one terminal receiving cavity and engaging the engagement member when fully positioned therein.

2. The electrical connector of claim 1, wherein the terminal retaining latch is cantilevered forwardly, and the tine is cantilevered rearwardly.

3. The electrical connector of claim 2, wherein the engagement member is defined as a cam member.

4. The electrical connector of claim 2, wherein the free end of the terminal retaining latch and the free end of the tine abut each other when in a pre-locked position.

5. The electrical connector of claim 4, wherein the free end of the terminal retaining latch and the free end of the tine are profiled to interlock when in a pre-locked position.

6. The electrical connector of claim 5, wherein the free end of the terminal retaining latch has a convex projection and the free end of the tine has a concave recess, the recess being profiled to interlock with the convex projection when in a pre-locked position.

7. The electrical connector of claim 4, wherein the free end of the terminal retaining latch and the free end of the tine are profiled to release from each other, if an excessive force is exerted on the TPA.

8. The electrical connector of claim 7, wherein the free end of the tine is angled rearwardly and downwardly in the longitudinal direction.

9. An electrical connector assembly, comprising a housing member comprising a housing body portion defining at least one terminal receiving cavity extending therethrough, and a terminal retaining latch at least partially overlying the at least one terminal receiving cavity; a terminal position assurance member (TPA) having a front wall with at least one aperture therethrough which aligns with the at least one terminal receiving cavity, a tine extending from the front wall and towards and abutting the terminal retaining latch when in a pre-locked position, and being positionable beneath the terminal retaining latch when a terminal is received in the at least one terminal receiving cavity and fully positioned therein, the TPA and the terminal retaining latch having cooperating and angled interengaging planar surfaces; and an electrical terminal positioned in the at least one terminal receiving cavity and aligned with the at least one aperture.

10. The sealed connector of claim 9, wherein the tine comprises an engagement member thereon profiled for contact by a terminal receivable in the at least one terminal receiving cavity.

11. The electrical connector of claim 10, wherein the terminal retaining latch is cantilevered forwardly, and the tine is cantilevered rearwardly.

12. The electrical connector of claim 10, wherein the engagement member is defined as a cam member.

13. The electrical connector of claim 11, wherein the free end of the terminal retaining latch and the free end of the tine abut each other when in a pre-locked position.

14. The electrical connector of claim 13, wherein the free end of the terminal retaining latch and the free end of the tine are profiled to interlock when in a pre-locked position.

15. The electrical connector of claim 14, wherein the free end of the terminal retaining latch has a convex projection and the free end of the tine has a concave recess, the recess being profiled to interlock with the convex projection when in a pre-locked position.

16. The electrical connector of claim 13, wherein the free end of the terminal retaining latch and the free end of the tine are profiled to release from each other, if an excessive force is exerted on the TPA.

17. The electrical connector of claim 16, wherein the free end of the tine is angled rearwardly and downwardly in the longitudinal direction.

18. The electrical connector of claim 9, wherein the TPA further comprises a wall which defines an inner surface of the connector assembly.
